(19) United States
(12) Patent Application Publication
(10) Pub. No.: US 2005/0175781 A1
(43) Pub. Date: Aug. 11, 2005

(54) Method and apparatus to produce decorative mouldings

(76) Inventor: David Schmidt, Fenwick (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 10/841,500

(22) Filed: May 10, 2004

(30) Foreign Application Priority Data
Feb. 5, 2004 (CA) 2,457,085

(51) Int. Cl. B05C 11/00; B05C 13/00

(52) U.S. Cl. 427/372.2; 427/402; 427/355; 118/70

(57) ABSTRACT

A method and apparatus to produce decorative mouldings, wall panel sections and columns, which are widely used in the construction industry. The method is a sequence of advancing a core, constructed from preformed expanded polystyrene (EPS), in a straight horizontal plane, with restraining devices preventing lateral and vertical movements, through a coating chamber. The coating chamber is filled with a thick liquid stucco or plaster or cement-like mixture and imparts a layer of the coating on the preformed core. The thickness of the coating layer is controlled with templates having an opening correspondingly larger than the core size and with the desired decorative profile. The apparatus can be configured to apply the coating on all sides of the core. In the case of a decorative moulding, the coating application can be limited to the exposed decorative surfaces only.

### FIELD OF THE INVENTION

This invention relates to decorative mouldings, wall panels and hollow decorative columns of the type used in the construction industry comprised of preformed foam cores with a stucco/plaster coating. The invention relates particularly to a method and apparatus for coating the cores with stucco/plaster.

### BACKGROUND OF THE INVENTION

Preformed and prefabricated components are becoming widely used in the construction industry. Examples of such components include prefabricated wall sections, trusses, preformed foam trims and arches.

Components also include decorative mouldings, wall panels and columns, preformed and finished and ready to be installed on the construction site. These components are typically comprised of an expanded polystyrene (EPS) core and coated with a plaster or stucco-like material to provide an attractive decorative finished surface. A fibre mesh can be applied to the core prior to coating to improve strength and durability.

The prevalent method of producing the decorative components is to align rows of the cores on plastic topped tables and staple or screw them to the tabletop. There could be as many as four rows of cores placed side by side on a 4 ft. wide table, extending up to 90 ft. long or more. If required, the cores would have had mesh applied prior to placing them on the table.

The coating material is poured from a pail along the length of the cores and massaged by hand on to the exposed surfaces of the cores. A box, with a steel template cut to a finish profile, is then slid along the length of the table, thus imparting the finished profile on the workpiece. The workpiece is allowed to dry, and another coating can be applied with a finer grained material to impart a smoother finish.

In the case of a decorative column, the cores are constructed in elongated halves and are placed on the tables with the split facing down. After coating the halves, they are bonded together and repaired at the seams.

After allowing the workpiece to completely dry, it is then pried off the table. The edges that were defined by the tabletop can be sanded and any minor imperfections can be repaired. The finished workpiece is then shipped.

This whole process takes about 24 hours and requires after clean up of the tabletops, removal of the screws and cleaning of the box and template. This method is very costly in terms of labour and space.

More recently, various types of automated equipment have been produced to apply the coating. For example, Canadian patent application serial number 2229933 filed on Feb. 19, 1998 by Oscar et al discloses a method and apparatus for coating a decorative workpiece. This apparatus drives a core through a coating chamber with a pair of conveyor belts with spikes penetrating the core from the bottom surface. The core is driven through a pressurized coating chamber by the conveyor belts. An elongate channel or dovetail is pre-cut in the bottom of the core that engages on a corresponding rail on the apparatus, and holds the core against lateral and vertical movement as it is coated. While this method and apparatus does provide a coating on the decorative surface of the .workpiece, it can be very troublesome in practice. If the cores are not tightly placed end to end with each other as they pass through the coating chamber, the coating material leaks on to the conveyor belts and rail. The leaked material can accumulate as lumps on the belts and impart an uneven finish on the workpiece. Furthermore, as the last core passes through the coating chamber, all the excess material falls onto the rail and spiked belts thus requiring a meticulous cleanup.

Additionally, the apparatus disclosed in Canadian patent application 2229933 does not allow for coating the underside of a core and is extremely limited in its application in coating decorative inside corner mouldings. Also, an undesirable channel or dovetail is required on the underside of the core. Furthermore, because the ends of the coating chamber are angled, the templates are not easily produced because of the complicated rendering of the resulting perpendicular section required on the workpiece.

Canadian patent 2,184,205 issued on Jan. 27, 1998 and reissued on Sep. 7, 1999 to 888804 Ontario Limited, discloses a method and apparatus for manufacturing decorative mouldings. In this method, the workpiece is driven by conveyor belts abutting both sides of the workpiece before passing through a coating chamber while being slidingly engaged with a continuous flat tabletop. While this apparatus does provide a coating on the decorative surface of the workpiece, it is also troublesome and limited in its application. Firstly, if the cores are not tightly butted up against each other, end to end, the coating material leaks on to the tabletop, accumulates and affects the thickness of the coating. Holding the cores against the tabletop as they pass through the coating chamber creates friction that makes the cores harder to drive through the coating chamber. For inside corner mouldings, the conveyor belts cannot drive against two corners on the sides of the core. The belts rip the corners of the core before entering the coating chamber. Slipping can occur which results in an uneven surface finish. Pieces of the core are carried into the coating chamber and contaminate the mix. The dies as illustrated in the patent with tapered openings having sharp inside corners are not easily achieved, except by hand grinding and filing, making them too costly. Additionally, the apparatus does not allow for coating the underside of the core.

Both of these apparatus and methods are intended to by set up and operated in a dedicated facility with an area set up for their use requiring costly floor space. Neither of the apparatus allow for the convenience of portability to the actual construction site.

Therefore, there is a need to develop a method and apparatus for coating the cored workpieces that allow for coating on all sides, that can be portable and is equipped with a drive mechanism and coating chamber that is not prone to the difficulties encountered with the prior art.

### SUMMARY OF THE INVENTION

To this end, in one of its aspects, the invention provides a novel method and apparatus for applying a plaster/stucco-like coating material to the surfaces of an elongate foam core. The foam core is preformed with a profile resembling the desired finish surface profile and may or may not have a reinforcing mesh applied to its surface prior to coating.

The foam core can be used for wall panels, decorative exterior/interior mouldings or columns.

Accordingly, the present invention discloses a method for applying a plaster/stuccolike coating to the surfaces of an elongate foam core comprising the steps of:
Continuously advancing the core in a straight horizontal plane, with hold down wheels constraining the core downwardly as it is penetrated along the bottom surface by a series of driving dogs;
Constraining the said cores, vertically and laterally, while inside a coating chamber, as the core advances through an input and output template as a plaster/stucco-like material is applied to the surfaces of the core;
Supporting the said core, while inside a coating chamber, vertically with ledges that adjust to slide under the bottom sides by approximately ¼″ in the case of coating only the visible decorative surfaces of a core;
Advancing the core through an input template opening made of steel or plastic with an opening corresponding to the profile of the core and large enough to accommodate the said core with enough clearance to allow the core to pass through the input template even if the core had been previously coated;
Advancing the core through an output template laminated with a steel template conforming to the desired finish profile. The said core being preformed to a shape conforming to the desired profile but correspondingly smaller by an amount equal to the desired thickness of the coating. A plastic template bonded or screwed to the steel template, thicker than the steel template, bevelled with the smaller opening corresponding to the steel template profile with the larger side opening up like a funnel with radiused corners facing inside the coating chamber;
Filling the coating chamber with plastic/stucco-like material by first inserting the foam core so that the input and output template openings are filled with the core, and keeping the coating chamber filled as the cores advance through, one after the other;
Advancing the coated core on to a roller conveyor or slotted table top and removing the core from the apparatus and placing the coated cores on racks or tables to dry;
Inserting the coated and dried cores back into the apparatus for a subsequent coating with a thinner or finer grained coating material to provide smoother surface;
Changing the output template to a larger profiled opening when applying a subsequent coating.

According to another object of the present invention is an apparatus for applying a plaster/stucco-like coating material to the surface of a profiled elongate foam core on all sides or on the desired exposed surfaces only, said apparatus comprising:
Means for advancing a core on a straight horizontal plane through the apparatus;
Means of constraining the core laterally and vertically as it advances through the apparatus;
Means to allow adjustment of the apparatus to take various size cores;
Means to allow configuration of a coating chamber to provide a continuous coating on all sides of a core;
Means to allow configuration of a coating chamber to provide a coating on the exposed surfaces only of a core;
Means to allow said apparatus to be portable with easily removable and packaged components;
Means of imparting a surface profile on the core surface by the use of a coating chamber with input and output templates;
Means of providing easy cleanout of the said coating chamber;

### BRIEF DESCRIPTION OF THE DRAWINGS

FIG. 1a is a perspective view of a apparatus of the present invention showing a core advancing through the apparatus. FIG. 1b is an enlargement of the central section of this apparatus.

FIGS. 2A and 2B show a perspective view of two decorative mouldings, one wall panel and one column.

FIG. 3A is an end view showing the core as it enters the coating chamber. FIG. 3B is a side view of the chain and sprocket assembly.

FIG. 4 is an end view showing the core as it inters the input template. Illustrated is the clearance required between the core and the template. Also shown is a configuration of the apparatus enabling a column to be coated on all surfaces.

FIG. 5 is a section view of the coating chamber facing the output template.

FIG. 6 shows the construction of the output template an a wire frame perspective of the plastic laminate.

FIG. 7 is a longitudinal side view section of the coating chamber illustrating the core advancing through.

FIG. 8a is a perspective view of one apparatus of the present invention showing a core advancing through the machine. FIG. 8b is an enlargement of the central section of this apparatus.

FIG. 9 is an end view showing the core as it enters the coating chamber. A side view of the chain and sprocket is shown below.

FIG. 10 is a perspective of a side guide.

### DETAILED DESCRIPTION OF THE PREFERRED EMBODIMENTS

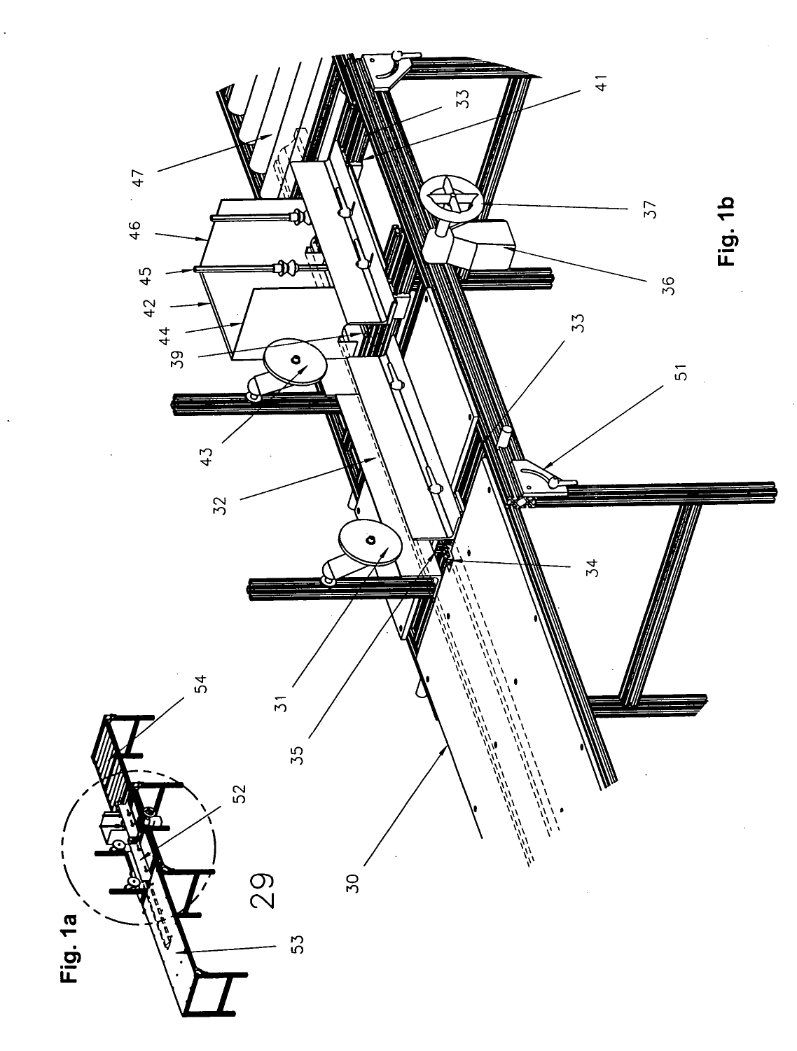

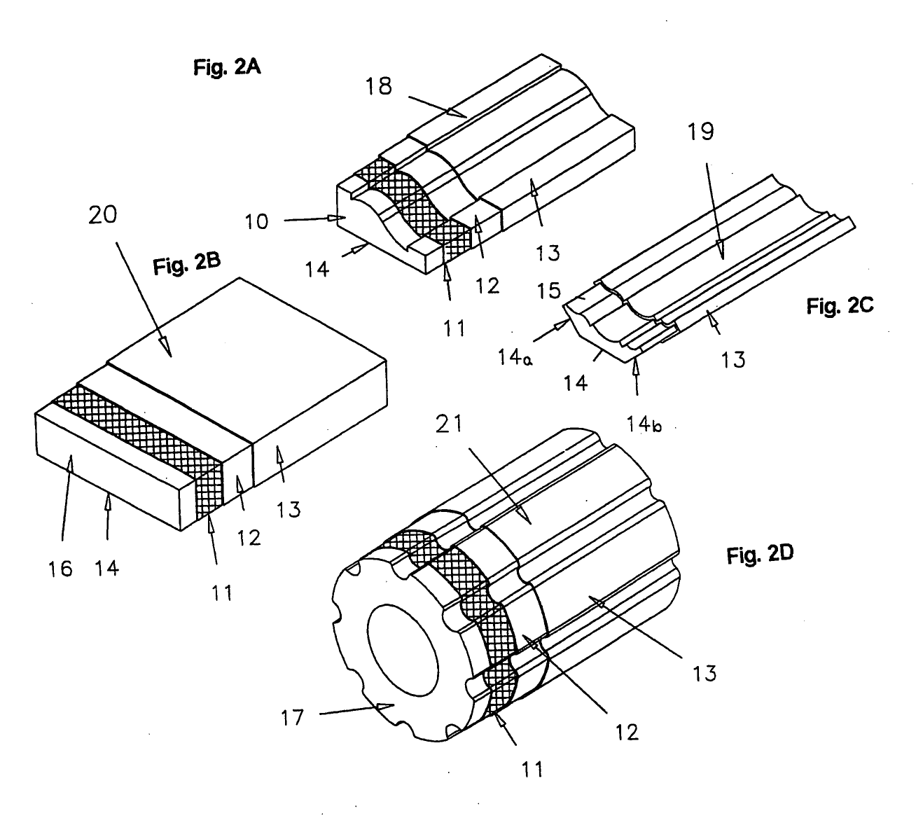

Referring to FIG. 1, there is illustrated apparatus 29 of the present invention This apparatus is intended to coat cores up to 18″ wide. The workpiece 18 as shown in FIG. 2a comprises a core 10 having an exterior decorative surface 13 which may be irregular in cross-section, but elongated and consistent along its entire length. A bottom surface 14 is flat and remains uncoated. A mesh 11 covers the entire decorative surface 13 of the workpiece and may overlap the sides to fold under on to surface 14.

The workpiece 18 of FIG. 2A is designed to be mounted on an exterior wall by cementing it in place via bottom surface 14. Workpiece 19 of FIG. 2C is an interior inside corner moulding and is attached by cementing surfaces 14a and 14b to a wall section. Workpiece 20 of FIG. 2B is a wall section. Workpiece 21 of FIG. 2D is a contoured column.

Apparatus 29 as shown in FIG. 1a is configured to take an exterior moulding core 10.

Referring to FIG. 1b, the foam core 10 is placed on loading table 30 and pushed by hand to go under hold down wheel 31 and between two side guides 32. The hold down wheel 31 is connected to a fully articulating arm attached to a column that allows for adjusting to different heights and widths of cores 10, 15, 16, 17. The side guides 32 slide on two rails 33 to allow for different core widths and allow the core to be centered in relationship to drive dogs 35.

Once the core is partially pushed into the side guides 32, driving dogs 35 that are connected to a chain and sprocket 34 are used to advance the core 10 further along horizontally. The chain and sprocket 32 can be powered by either a hand wheel 37 manually or engaging a variable speed motor 36.

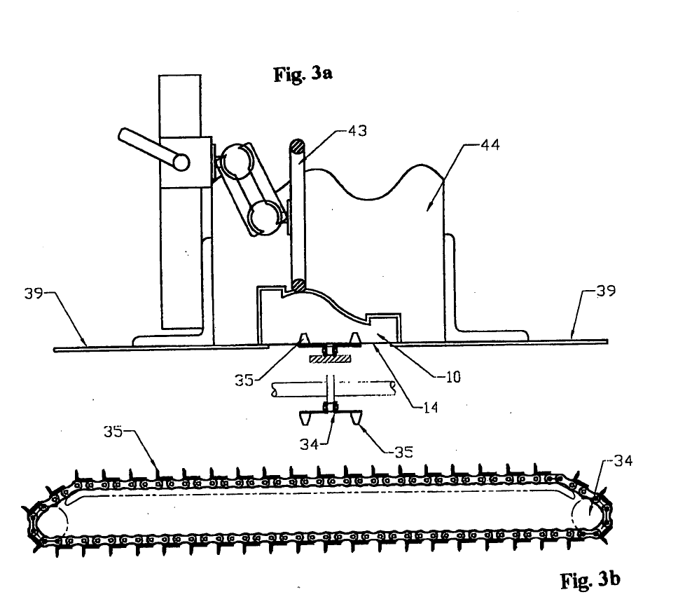

The leading edge of the core 10 passes through the side guides 32 and is pressed down by a second hold down wheel 43 and continues on through the input template 44. FIG. 3a discloses a sectional view of core 10 as it leaves the side guides 32, looking towards the input template.

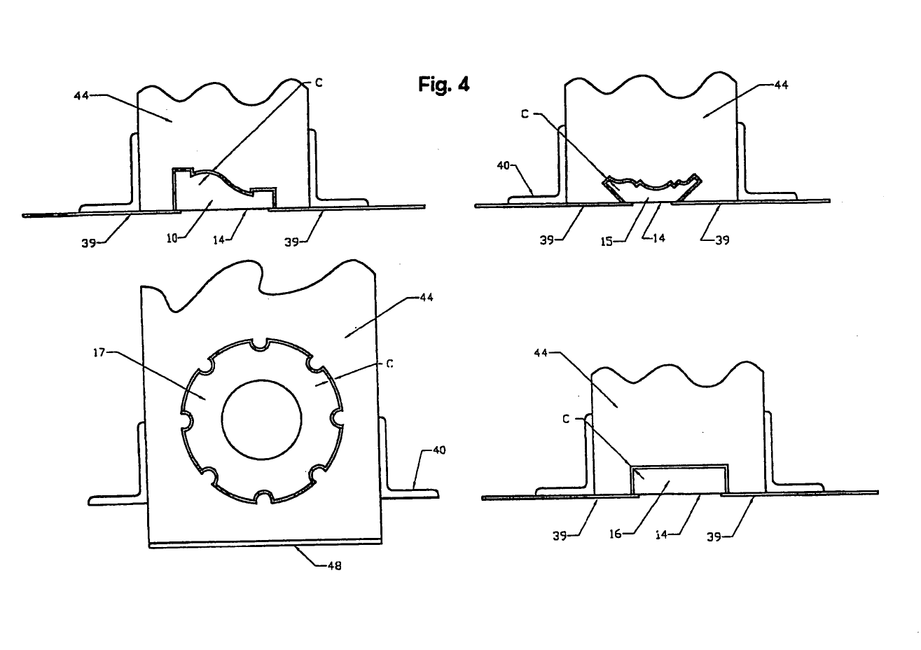

Core 10 advances through the input template 44 and into the coating chamber. The input template 44 is cut with a profile slightly larger than the core 10. FIG. 4 illustrates the core 10,15,16,17 entering the input template 44. The clearance “C” has to be enough so that if the core requires more than one pass through the apparatus, it can still fit through the template with some allowance for irregularities.

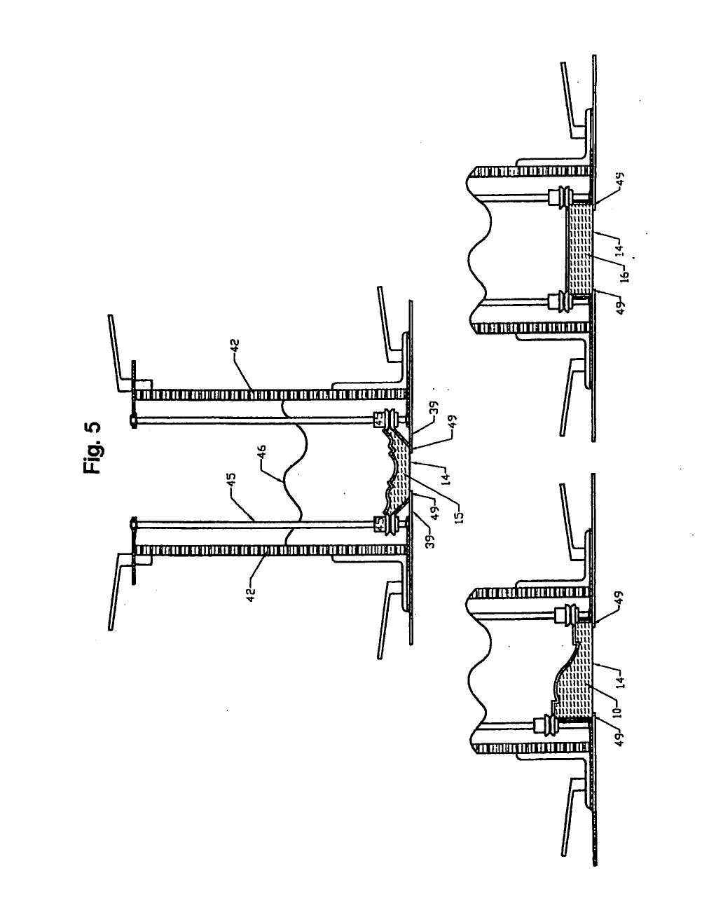

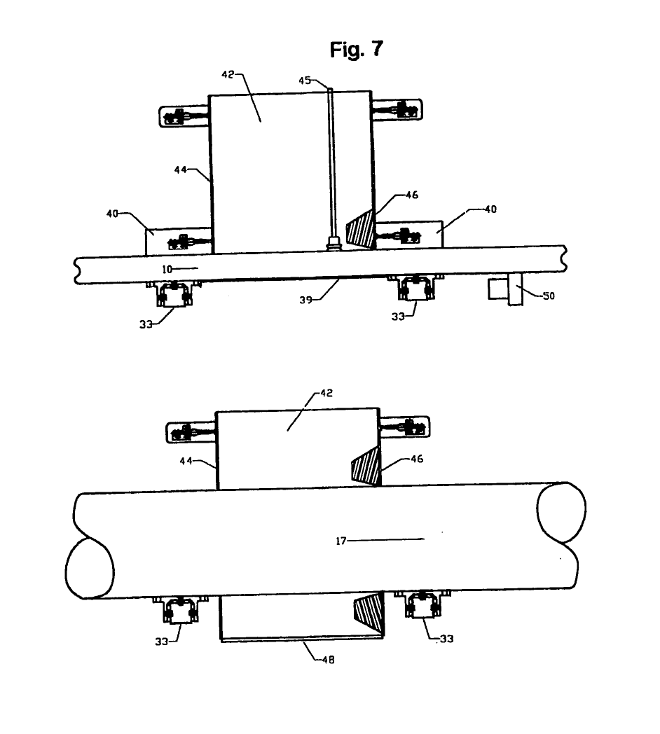

Referring to FIG. 5, the core 10 continues to advance through the coating chamber. The coating chamber is defined as a box having laterally adjustable sidewalls 42, an input template 44, an output template 46 and a coating chamber bottom 48 (see FIG. 7).

Referring to FIG. 5, the core 10 advances into the guide wheel assembly 45. The guide wheel assembly 45 adjusts vertically and laterally and is shaped to roll against the top corners of the core 10,15,16. The guide wheel assembly is designed to align the core laterally to the exit template 46 and holds the core down against laterally adjustable support ledge plates.

Referring to FIG. 5, the support ledge plates 39 are intended to provide a vertical supporting surface for cores 10,15,16 and are laterally adjustable so that the ledge extends under the bottom surface 14 by approximately ¼″, thus reducing friction that would be encountered with a continuous supporting surface. The support ledges 39, in combination with core 10,15,16, form a sliding seal 49 that prevents the coating material from escaping through the bottom.

When the last core 10,15,16 passes through the coating chamber, the ledge seal 49 no longer exists and thus the excess coating material is free to fall through into a collection pail.

In the case of core 17, the guide wheel assembly 45 and support ledges 39 are not used. Referring to FIG. 4, the templates 44 and (46 not shown) are extended to protrude below the core 17 and a bottom 48 is attached.

Referring to FIG. 1, the core advances through the output template 46.

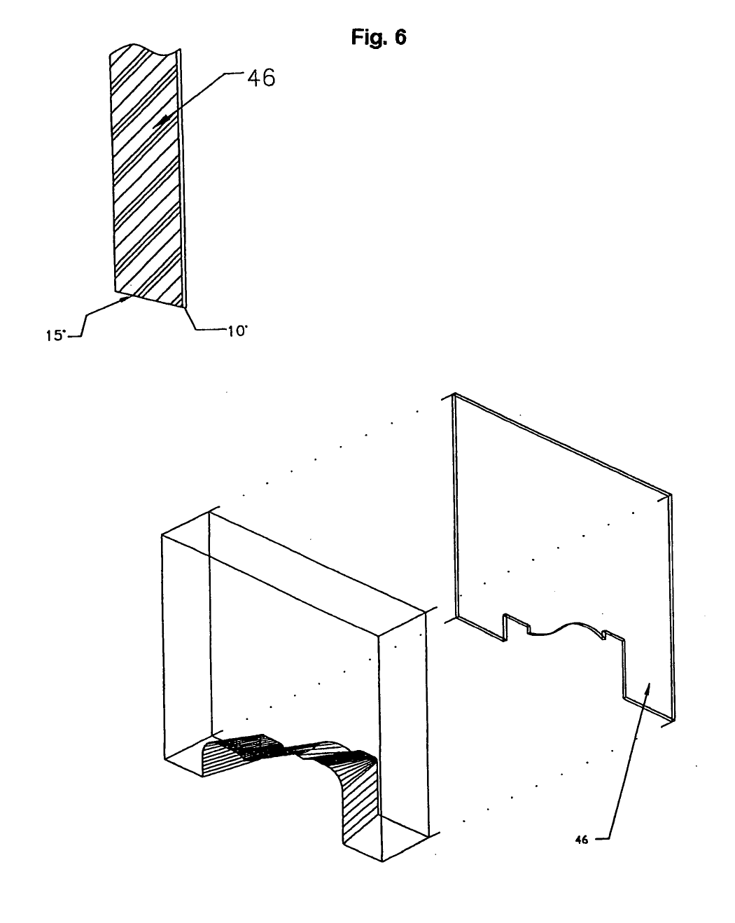

Referring to FIG. 6, the output template 46 is made form from a steel plate that may be laminated to a thicker bevelled plastic template that funnels the coating material on to the surface of the core 10,15,16,1.7. The plastic portion is generally profiled to conform to the steel profile but is radiused in the corners and the edges. The radii are tapered forming a coned profile that increases in radius the further back from the plate side at an angle equal to the plastic bevel angle.

The output template 46 is sized to the desired dimension of the finish workpiece 18,19,20,21. The core 10,15,16,17 was preformed smaller than the finished workpiece by an amount equal to the desired coating thickness.

Referring to FIG. 7, the cross section horizontally through the coating chamber is illustrated. In the case of core 17, the input template 44 and the output template 46 can be place closer together, based upon the size of core 17 and how much said core can be extended through the coating chamber unsupported.

As the core advances past the output template 46, scraper 50 removes any excess material that may have squeezed on to the bottom edge 14.

Referring to FIG. 1, the now coated workpiece 18,19,20 advances on to an output roller conveyor 47 and can be lifted off by hand and placed on drying racks.

Uncoated cores are continuously fed end to end into the side guides 32. No gap is permitted between the cores; otherwise the coating material would fall through the coating chamber.

The entire apparatus 29 can be disassembled into four sections for ease of portability. The coating section 52 has four hinged legs 51 that can be folded for storage. Input section 53 fits into a channel in coating section 52 and can be locked in place. The input section had two hinged legs 51. Output section 54 fits into a channel of coating section 52 and also has two hinged legs 51 and can be locked in place.

Drive motor 36 and hand wheel 37 are designed to slip on and off for shipping,

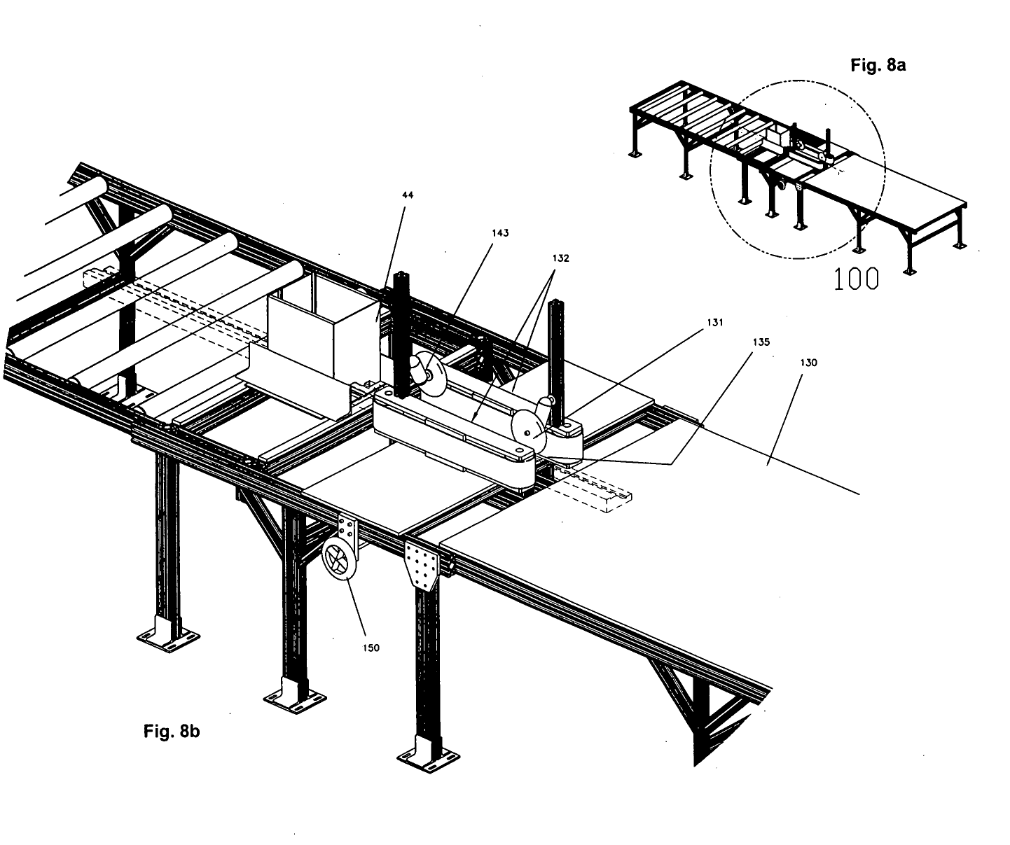

Another embodiment of the present invention is apparatus 100 shown in FIGS. 8a, 8b. This apparatus is more heavy duty in nature and is capable of coating cores up to 36″ wide and is not intended to be portable.

Apparatus 100 as shown on FIGS. 8a, 8b is illustrated to take core 10.

The core 10 is placed on a loading table 130 and pushed by hand under hold down wheel 131 and between the two rotating side guides 132. The hold down wheel 131 is connected to a fully articulating arm attached to a column that allows for adjusting to different heights and widths of cores 10,15,16. The rotating side guides 132 slide on two rails. A width adjusting mechanism 150 comprised of a hand wheel, rack and pinion and bevel gears adjusts the opening between the two rotating side guides 132 to allow for different core sizes. By turning the hand wheel on adjusting mechanism 150, both rotating side guides move laterally simultaneously, thus adjusting for various widths and maintaining centrality on the table and in relationship to drive dogs 135.

Once the core 10 is partially pushed into the rotating side guide 132, driving dogs 135, penetrate into the bottom 14 of the core 10 and advances the core further along horizontally. As with apparatus 29 FIG. 1, rotating a hand wheel 37 manually, or engaging a variable speed motor 36 can power the chain and sprocket 134.

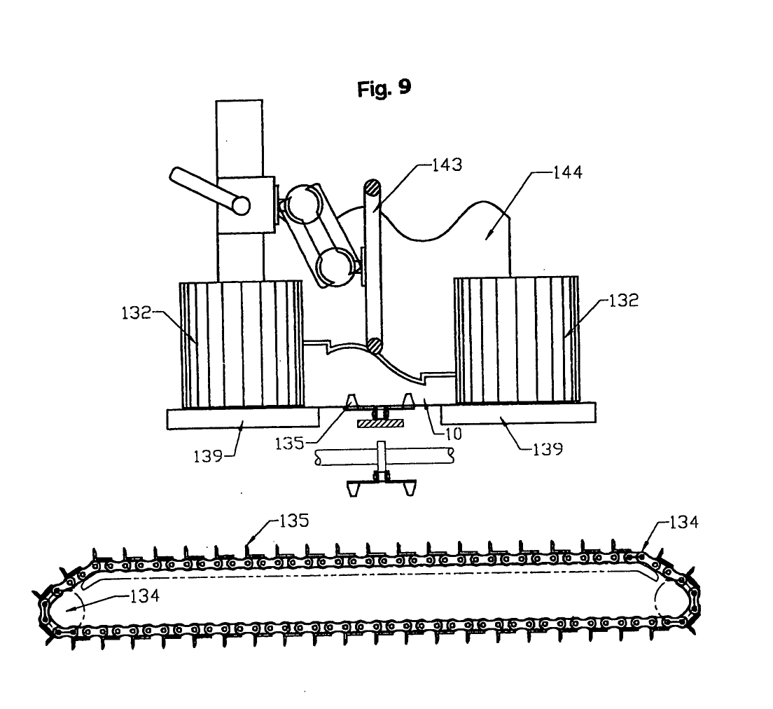

Referring to FIG. 9, the leading edge of the core 10 advances through the side guides 132 and is pressed down by a second hold down wheel 143 and advances to the input template. FIG. 9 is a section view taken through the side guides 132 looking towards the coating chamber.

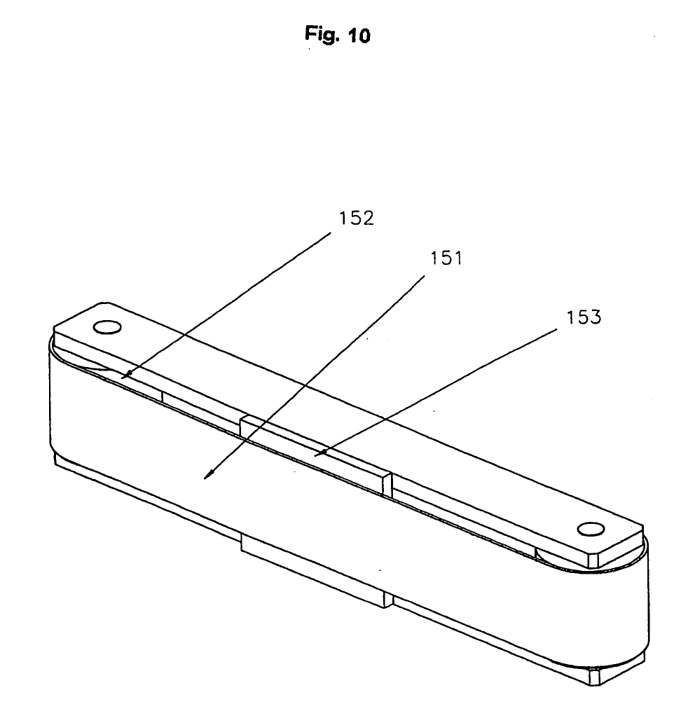

The rotating side guides 132 are connected to the chain and sprocket 134 by a set of bevel gears that rotate the side guides 132 synchronous to the chain and sprocket 134. Referring to FIG. 10, the side guides are comprised of a belt 151 and two rollers 152 with a backing pad 153.

As the chain and sprocket 134 advances the drive dogs 135, the side guide belts 151 rotate at the same speed and centrally locates and guides the core 10. The core 10 is thus advanced by drive dogs 135 and held central by the guide belts 151 without the core encountering side sliding friction.

Referring to FIG. 4, core 10 advances to the input template 44. The input template is cut with a profile slightly larger than the core 10,15,16 with enough clearance that if the core requires more than one coating pass, it can still fit through with some allowance for irregularities.

The core 10 continues to advance into the coating chamber and is guided by the guide wheel assembly 45 (see FIG. 5). The configuration of the coating chamber is the same as the first apparatus except for bottom ledge 39 is replaced with support fork 139 (see FIG. 9).

The support fork 139 is an extension of the rotating side guides 132 and operates laterally for core size adjustment by actuating the width adjustment mechanism 150. This provides the ability to make one adjustment to set the correct width and ledge support.

The remainder of the second embodiment works the same as the first embodiment except that it is larger and without portability.

While many specific structural details have been disclosed, it will be understood that it is capable of many modifications and that this application is intended to cover any variation, uses, adaptions of the invention, following in general the principles of the invention including such departures from the present disclosure as to come within the knowledge of customary practice in the art, and as may be applied to the essential features hereinbefore set forth and falling within the scope of the invention or the limits of the appended claims.

1. A method for applying a coating to the surface of an elongated foam core having a decorative exposed surface, said method comprising the steps of:
(a) securing said elongated preformed foam core to an elongated flat surface;
(b) advancing said core along said elongated surface to a coating chamber;
(c) applying a coating material to the entire surface of said core;
(d) moving said coated core to the outside of said coating chamber;
(e) removing said coated core from said elongated surface; and
(f) drying said coated core.

2. A method as claimed in claim 1 wherein said coating material applied to the entire surface of said core is a plaster coating material.

3. A method as claimed in claim 1 wherein said coating material applied to the entire surface of said core is a stucco coating material.

4. A method as claimed in claim 1 wherein said elongated foam core is secured to the flat surface of an elongated flat table.

5. A method as claimed in claim 1 wherein said core is advanced along the elongated surface along the longitudinal axis of said flat surface by guide means.

6. A method as claimed in claim 5 wherein said guide means are adjustable side guides adapted to move said core along said elongated surface in a predetermined direction.

7. A method as claimed in claim 5 wherein said guide means move said elongated foam core by using adjustable side guides located on each side of said core and hold down wheels adapted to move said foam core.

8. A method as claimed in claim 5 wherein said guide means include drive means adapted to engage the bottom of the core and move said core in said predetermined direction.

9. A method as claimed in claim 1 wherein the method is repeated and said elongated foam core is coated with a second thicker coating.

10. A method as claimed in claim 1 further including the step of coating the exposed decorative surface.

11. An apparatus for applying a coating to the surface of a preformed elongated core, said apparatus comprising:
(a) a flat, elongated surface to support said core as it is moved horizontally in a first direction;
(b) guide means to guide the movement of said core;
(c) a coating chamber to provide a continuous coating on all sides of said core;
(d) surface profile means to impart a surface profile to said core; and
(e) clean out means for cleaning said apparatus.

12. An apparatus as claimed in claim 10 wherein said elongated flat surface is the top surface of a support table.

13. An apparatus as claimed in claim 10 wherein said guide means comprises adjustable input slide guides to align the core longitudinally and means to advance the core through said coating chamber.

14. An apparatus as claimed in claim 10 wherein said guide means comprises hold down wheels for retaining the elongated foam core to the surface of said table thus engaging said core with a plurality of secondary drive means which penetrate into the bottom surface of said core.

15. An apparatus as claimed in claim 10 wherein said apparatus is a table having folding legs.

16. An apparatus as claimed in claim 13 wherein the position of said hold down wheels are maintained by an articulating arm to allow for universal adjustment for core sizes and shapes.

17. An apparatus as claimed in claim 13 wherein said hold down wheels comprises a contact surface having a rubber to prevent damage to the coated core.

18. An apparatus as claimed in claim 10 wherein said guide means includes drive dogs attached to a standard roller chain for moving said core.
